(19) United States
(12) Patent Application Publication
(10) Pub. No.: US 2014/0279751 A1
(43) Pub. Date: Sep. 18, 2014

(54) AGGREGATION AND ANALYSIS OF MEDIA CONTENT INFORMATION

(71) Applicant: Deja.io, Inc., San Francisco, CA (US)

(72) Inventors: Nimrod Ram, Tel-Aviv-Yaffo (IL); John Root Stone, San Francisco, CA (US); Avner Shilo, Oakland, CA (US); Lucas Heldfond, San Francisco, CA (US)

(73) Assignee: Deja.io, Inc., San Francisco, CA (US)

(21) Appl. No.: 14/208,977

(22) Filed: Mar. 13, 2014

Related U.S. Application Data
(60) Provisional application No. 61/779,315, filed on Mar. 13, 2013.

(51) Int. Cl. G06N 99/00

(52) U.S. Cl. CPC G06N 99/005
USPC 706/12

(57) ABSTRACT

Disclosed are the method and apparatus for collecting and analyzing media content metadata. The technology retrieves web documents referencing media objects from web servers. Metadata of the media objects such as global tags and category weight values are generated from the web documents. Affinity values between user identities and the media objects are generated based on online behaviors of the users interacting with the media objects. Based on the affinity values and metadata of the media objects, the technology can provide recommendations of media objects.

### CROSS-REFERENCE TO RELATED APPLICATION

This application claims the benefit of U.S. Provisional Patent Application No. 61/779,315, entitled “COMPUTER READABLE STORAGE MEDIA, APPARATUSES, SYSTEMS, AND METHODS FOR CATALOGING MEDIA CONTENT AND PROVIDING MEDIA CONTENT”, which was filed on Mar. 13, 2013, which is incorporated by reference herein in its entirety.

### BACKGROUND

The traditional manner of recommending media content is inefficient to both users and content providers. For instance, a content provider may manually create categories for the media content and manually assign media content to the categories. When the content provider detects that a user has consumed one or more instances of media content of a particular category, the content provider may recommend more media content within the same category to the user. Such a recommendation is not accurate because the user may not be interested in other media contents within that particular category. Furthermore, this type of recommendation ignores the varied interests of users which results in the user receiving recommendations from the content provider that are of little interests to the user.

Alternatively, the content provider may present thumbnails of the media content to the user. The user can select one of the thumbnails as an indication of an interest in the media content. However, thumbnails provide little information regarding the actual media content. The user may discover later that the user is not really interested in the media content selected based on the thumbnail. Such a media content selection process is inefficient and cumbersome.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates an environment in which the media content analysis technology can be implemented.

FIG. 2 illustrates an example of a process of analyzing web documents and generating global tags.

FIG. 3 illustrates an example of a process of categorizing a media object based on web documents referencing the media object.

FIG. 4 illustrates an example of a process of generating affinity values between a media object and users.

FIG. 5 illustrates an example of a process of aggregating various types of media content metadata.

FIG. 6 illustrates an example of a process of determining feature vectors based on metadata of media objects.

FIG. 7 illustrates an example of a process of recommending a media object to a user.

FIG. 8 illustrates another example of a process of recommending a media object.

FIG. 9 illustrates an example of a client device receiving a media object recommendation.

FIG. 10 is a high-level block diagram showing an example of a processing system in which at least some operations related to media content analysis or recommendation can be implemented.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive.

Introduced here is a technology for collecting and analyzing media content metadata of various types of media objects. The media content metadata can be used to recommend media objects to users. By extracting tags from web documents that reference the media objects, global tags can be generated along with the associated confidence weight values. The confidence weight values indicate confidence levels upon which the global tags relate the media objects.

A trained classifier can be used to determine the categories of the media objects, by feeding the textual content of the web documents to the trained classifier. The trained classifier generates category weight values that indicate a confidence level which confirms that respective media objects belong to associated categories.

The technology can further monitor online behaviors of users as users interact with the media objects. Such an interaction may include commenting on or discussing the media objects. The technology generates affinity values between the users and the media objects based on metrics of these online behaviors. An affinity value indicates how closely a user and a media object are related.

The collected metadata for a particular media object (“feature vector”) can include the global tags for the media object and associated confidence weight values, the categories for the media object and associated category weight values, and the identifications of the users and associated affinity values between the particular media object and the users. Using the metadata for the media objects, the technology can recommend media objects to users.

For instance, the technology can generate feature vectors of the users based on media object metadata. Elements of each feature vector represent the corresponding user's relationships with the global tags, the categories, and all other users. The technology may utilize the feature vectors in various ways. For example, the technology may identify neighboring users having similar feature vectors and recommend media contents that are ranked and aggregated from the neighboring users to the user through a collaborative filtering scheme. Alternatively, the technology may search the feature vector space of media objects to identify and recommend a media objects with feature vectors that minimize a custom distance function with the feature vector of the user.

FIG. 1 illustrates an environment in which the media content analysis technology can be implemented. The environment includes a media content analysis system 100. The media content analysis system 100 is connected to client devices 192 and 194 (also referred to as “client” or “customer”). The client device 192 or 194 can be, for example, a smart phone, tablet computer, notebook computer, or any other form of mobile processing devices. The media content analysis system 100 can further connect to various servers including, e.g., media content delivery server 180, social media server 182, general content server 184. The general content server 184 can provide, e.g., news, images, photos, or other media types. Each of the aforementioned servers and systems can include one or more distinct physical computers and/or other processing devices which, in the case of multiple devices, can be connected through one or more wired and/or wireless networks.

The media content delivery server 180 can be a server that hosts and delivers, e.g., media files or media streams. The media content delivery server 180 may further host webpages that provide information regarding the contents of the media files or streams. The media content delivery server 180 can also provide rating and commenting web interfaces for users to rate and comment on the media files or streams.

A social media server 182 can be a server that hosts a social media platform. Users can post messages discussing various topics, including media objects, on the social media platform. The posts can reference media objects that are hosted by the social media server 182 itself or media objects that are hosted externally (e.g., by the media content delivery server 180).

A general content server 184 can be a server that serves web documents and structured data to client devices or web browsers. The content can reference media objects that are hosted online. The media content analysis system 100 may connect to other types of server that hosts web documents that reference media objects.

The media content analysis system 100 can be coupled to the client devices 192 and 194 though an internetwork (not shown), which can be or include the Internet and one or more wireless networks (e.g., a WiFi network and or a cellular telecommunications network). The servers 180, 182 and 184 can be coupled to the media content analysis system 100 through the internetwork as well. Alternatively, one or more of the servers 180, 182 and 184 can be coupled to the media content analysis system 100 through one or more dedicated networks, such as a fiber optical network.

The client devices 192 and 194 can include API (application programming interface) specifications 193 and 196 respectively. The API specifications 193 and 196 specify the software interface through which the client devices 192 and 194 interact with the client service module 170 of the media content analysis system 100. For instance, the API specifications 193 and 196 can specify the way how the client devices 192 and 194 request media recommendation from the client service module 170. Alternatively, the API specifications 193 and 196 can specify the way how the client devices 192 and 194 retrieve media object metadata from the client service module 170.

The media content analysis system 100 collects various types of information regarding media contents from the servers 180, 182 and 184. The media content analysis system 100 aggregates and analyzes the information. Through the analysis, the media content analysis system 100 generates and stores metadata regarding the contents of the media objects. Using the metadata, the media content analysis system 100 can provide various types of service associated with media objects to the client devices 192 and 194. For instance, based on media objects that the client device 192 has played, a client service module 170 of the media content analysis system 100 can recommend similar or related media objects to the client device 192. Media objects can include, e.g., a video file, a video stream, an audio file, an audio stream, an image, a game, an advertisement, a text, or a combination thereof. A media object may include one or more file-type objects or one or more links to objects. To analyze the information related to the contents of the media objects, the media content analysis system 100 can include, e.g., a global tag generator 120, a NLP (Natural Language Processing) classifier 130, a behavior analyzer 140, a numeric attribute collector 150, a metadata database 160 and a client service module 170. The global tag generator 120 is responsible for generating tags by parsing web documents through templates that are specific to the web domains. The web documents can include, e.g., HyperText Markup Language (HTML) documents; Extensible Markup Language (XML) documents; JavaScript Object Notation (JSON) documents; Really Simple Syndication (RSS) documents; or Atom Syndication Format documents.

The NLP classifier 130 is responsible for classifying the media objects into pre-determined categories. By feeding textual contents of the web documents, the NLP classifier 130 is configured to provide category weight values that indicate confidence levels which confirming a particular media object belongs to certain categories. In alternative embodiments, the media content analysis system 100 can include a classifier other than the NLP classifier to categorize the media objects based on the contents of the web documents as well.

The behavior analyzer 140 monitors and analyses online users' behaviors associated with media objects in order to generate affinity values that indicate the online users' interest in certain media objects.

The numeric attribute collector 150 is responsible for collecting non-textual or numerical metadata regarding the media objects from the web documents. Such non-textual or numerical metadata can include, e.g., view counts, media dimensions, media object resolutions, etc.

The metadata database 160 is responsible for organizing and storing the media content metadata generated by the global tag generator 120, the NLP classifier 130, the behavior analyzer 140 and numeric attribute collector 150. For instance, using the metadata stored in the metadata database 160, the client service module 170 may identify two similar or related media objects and, based on the similarity or relatedness, may recommend one of these media objects to a client device 192 or 194. The following figures illustrate how different types of media content metadata are generated.

FIG. 2 illustrates an example process for analyzing web documents and generating global tags, according to various embodiments. The process can be performed by, e.g., the global tag generator 120 of the media content analysis 100. Initially the media content analysis system 100 receives web documents 210 that relate to or reference one or more media objects from external servers, such as media content delivery server 180, social media server 182, general content server 184. The media content analysis system 100 can retrieve and analyze different types of web documents 210, including HyperText Markup Language (HTML) documents; Extensible Markup Language (XML) documents; JavaScript Object Notation (JSON) documents; Really Simple Syndication (RSS) documents; or Atom Syndication Format documents.

The web documents are fed into one or more specific parser template of the global tag generator 120 to generate raw tags. Each specific parser template is specifically designed for a particular web domain. In some embodiments, the specific parser template is automatically generated based on the document formality of the particular web domain. The specific parser template can be further updated dynamically based on the formality of the received web documents.

The specific tag generator 120 determines a web domain that hosts a particular web document, and uses a template 220 specific to the web domain for parsing the particular web document. For instance, a social media website may host a social media comment discussing a video. The specific tag generator 120 can use a template 220 specifically designed for the social media website for parsing the social media comment and extracting the tags.

The specific parser template 220 can include a protocol parser 222 or more protocol parsers. Different types of web documents are formatted under different protocols. The specific tag generator 120 uses the protocol parser 222 to identify the textual contents of the web documents. For instance, the protocol parser 222 can retrieve the contents of a HTML document by ignoring texts outside of the <body> element and removing at least some of the HTML tags.

The specific parser template 220 can further include a regular expression (“RegEx”) tag extractor 224. The RegEx tag extractor 224 specifies rules to extract raw tags 230 from the web documents. For instance, the RegEx tag extractor 224 can define a search pattern for HTML documents from a particular web domain to locate textual strings that match the search pattern to capture the tags and the unstructured text.

The global tag generator 120 uses a preliminary processor 240 to perform preliminary processing on the generated raw tags 230. For instance, the preliminary processor 240 can perform typo (i.e., typographical error) correction 242 on the raw tags, If a raw tag is not found in a dictionary, the raw tag is compared to the existing words in the dictionary by, e.g., calculating Levenshtein distances between the raw tag and the existing words. A Levenshtein distance is a string metric for measuring the difference between a raw tag and an existing word. If the Levenshtein distance is below a threshold value, the preliminary processor 240 identifies the raw tag as having a typo and replaces the raw tag with an existing word.

The preliminary processor 240 can further perform common words exclusion 244 by accessing a dictionary including common words (not necessarily the same dictionary used for typo correction 242). If a raw tag belongs to the common words identified by the dictionary, the preliminary processor 240 can exclude that raw tag from further analysis.

The preliminary processor 240 can also perform stemming and lemmatization processes 246 on the raw tags 230. The preliminary processor 240 may reduce a raw tag from an inflected or derived word to a stem word form (i.e., stemming process). For instance, the preliminary processor 240 may reduce “dogs” to a stem form of “dog”, “viewed” to “view”, and “playing” to “play”. The preliminary processor 240 may further group raw tags as different forms of a word together as a single raw tag (i.e., lemmatization process). For instance, raw tags “speaking”, “speaks”, “spoke” and “spoken” can be lemmatized into a single raw tag “speak”.

The preliminary processor 240 can further perform a word sense disambiguation process 248, e.g., a Yarowsky process, on the raw tags 230. A raw tag may exhibit more than one sense in different contexts. The disambiguation process 248 can feed contextual texts of a raw tag into a pre-trained disambiguation classifier to identify the word senses (e.g., meanings) of the raw tag.

In some embodiments, affinity values (illustrated in FIG. 4) associated with a media object can be used to refine the process of generating global tags. For instance, when the preliminary processor 240 performs the disambiguation 248 on the raw tags 230, the preliminary processor 240 may consider word senses that are popular in other media objects that share strong affinities with the same user subset.

After the raw tags 230 are preliminarily processed by the preliminary processor 240, the global tag generator 120 uses a confidence weight assessor 250 to assess the raw tags. The confidence weight assessor 250 may assess various factors of the raw tags 230. For instance, the confidence weight assessor 250 may calculate a term frequency-inverse document frequency (TF-IDF) 252 for each raw tag. The TF-IDF is a numeral indicating the significance of a raw tag to a web document. The TF-IDF value increases proportionally to the number of times a raw tag appears in the web document, but is offset by the frequency of the word in a corpus. The corpus is the collection of all extracted tags, which help to control for the fact that some raw tags are generally more common than other tags.

The confidence weight assessor 250 can take into account the various confidence values generated during the work of the preliminary preprocessor 240 to generate an aggregated process confidence value 254. For example, if a typo correction 242 was performed on the original tag, the value of the Levenshtein distance between the original and corrected form can be used as an inverse confidence level.

For each raw tag, the confidence weight assessor 250 can calculate a confidence weight value based on the factors (e.g., the TF-IDF value 252 and the aggregated process confidence value 254). The confidence weight value associated with a tag indicates how closely the tag relates to the media object being referenced by the web document.

The global tag generator 120 then performs a ranking process 260 on the raw tags based on the confidence weight values. The global tag generator 120 may select a number of tags from the top of the ranked list as global tags 270 for the media object. The global tags 270 and their associated confidence weight values are stored in the metadata database 160 as part of the metadata of the media object. In other words, the web documents can include unstructured information regarding the contents of the media object. The global tags 270 can be structured information regarding the contents of the media object.

Besides the global tags, the media content analysis system 100 can also categorize a media object based on the web documents that reference the media object. FIG. 3 illustrates an example of a process of categorizing a media object based on web documents that reference the media object, according to various embodiments. The process can be performed by, e.g., the NLP classifier 130 of the media content analysis 100. Initially the media content analysis system 100 receives web documents 310 that reference the media object from one or more external servers, such as media content delivery server 180, social media server 182 or general content server. The media content analysis system 100 can retrieve and analyze different types of web documents 310, including, e.g., HTML, XML, JSON, RSS or ATOM documents.

The web documents 310 are fed into one or more protocol parsers 320. The protocol parser 320 recognizes the protocols used to format the web documents 310 and identifies the textual contents 330 of the web documents 310 based on the recognized protocols. For instance, the protocol parser 320 can recognize a RSS document and extract actual textual contents of the document based on the RSS protocol and standard. The protocol parser 320 may be the same protocol parser 222 used by the global tag generator 120, or may be a parser different from the protocol parser 222.

The extracted textual contents 330 are fed into a trained classifier 340 to identify the categories to which the media object belongs. The classifier 340 can include multiple sets of categories. Using training set data that have determined categories, the classifier 340 is trained for these categories. For each category, the trained classifier 340 provides a category weight value based on the fed textual contents. The category weight value indicates whether the media object belongs to the associated category. The category weight values 350 are stored in the metadata database 160 as part of the metadata of the media object.

In some embodiments, there can be a feedback mechanism to refine the accuracy of the classifier. For instance, a human operator can perform the feedback process by manually approving or declining the categorized results (e.g., the category weight values for the categories) from the classifier. Using the approving and declining feedback, the classifier can adjust itself to improve the categorizing accuracy.

In some alternative embodiments, the feedback process can be automatic and without a human operator or supervisor. A rule-based system can compare the categorizing results from the classifier with indicative tags from the process of generating global tags. For instance, the classifier may categorize a media object as FUNNY with a category weigh value of 95% while a HILARIOUS global tag of the same media object has an associated confidence weight value of 10%. This suggests that the classifier may be wrong in predicting the category FUNNY. When the global tag has a confidence weight level inconsistent with the category weight value, the classifier can use this inconsistency as negative training feedback and can adjust itself accordingly to improve the categorizing accuracy.

Besides the global tags and categories, the media content analysis system 100 can also generate affinity values between media objects and users as metadata of the media objects. FIG. 4 illustrates an example of a process of generating affinity values between a media object and users, according to various embodiments. The behavior analyzer 140 of the media content analysis system 100 continues monitoring users' online behaviors with regard to the media object. The users can include clients and third parties. Clients are users who receive media recommendation and other services from the media content analysis system 100. Third parties are users who do not receive media recommendation or other services from the media content analysis system 100 or who are not affiliated with the media content analysis system 100. The behavior analyzer 140 can monitor the user behaviors by retrieving information of users' interaction with the media object from various servers, such as the media content delivery server 180, social media server 182 or general content server.

The behavior analyzer 140 organizes the information of users' interaction as client behavior analytics 470 and third party behavior analytics 472. The behavior analyzer 140 can recognize various types of metrics (i.e., internal behavior data 474) from the client behavior analytics 470. For instance, the internal behavior data 474 may include a view time of the media object. A longer view of the media object suggests the client has a greater interest in the media object. The behavior analyzer 140 may also track when the client skips the media object, suggesting the client's lack of interest in the media object. The internal behavior data 474 may include the number of times a client repeatedly consumes the media object. The behavior analyzer 140 may record social actions, such as that the client likes (e.g., by clicking a “like” link or button) the media object or that the client explicitly rates the media object (e.g., by giving a number of stars).

The behavior analyzer 140 sets an affinity value 480 between the client and the media object by determining a weighted summation of these internal behavioral data 474. The affinity value 480 indicates how closely the client's interest matches the media object.

Similarly, the behavior analyzer 140 can also recognize external behavior data 476 from the third party behavior analytics 472 of a third party. The external behavior data 476 may include the same metrics as, or different metrics from, the metrics of the internal behavioral data 474. The behavior analyzer 140 sets an affinity value 480 between the third party and the media object by determining a weighted summation of these external behavioral data 476. The affinity values 480 and their associated user identities are stored in the metadata database 160 as part of the metadata of the media object.

In some embodiments, the affinity values are generated globally, based on user behaviors toward the media objects on servers across the Internet. For example, user affinities can be generated by collecting reviews of media content on a social media server 182 and using textual sentiment analysis to estimate the affinity between a user and a reviewed media object.

In some alternative embodiments, the affinity values are generated locally, based on user behaviors toward the media objects within a single channel. The locally generated affinity values may be used for recommendations of media objects inside of a particular channel. Alternatively, both locally and globally generated affinity values may be used together for recommending media objects.

FIG. 5 illustrates an example of a process of aggregating various types of media content metadata, according to at least one embodiment. The web document referencing media objects 510 are processed by using, e.g., processes illustrated in FIGS. 2 and 3. For each media object, multiple global tags and their associated confidence weight values are generated as metadata of the media object. The confidence weight value indicates a confidence level confirming whether or not the associated global tag relates to the media object.

Similarly, for each media object, the categories weight values are generated with regard to each category predicted by the NLP classifier (or other types of classifiers). The category weight value indicates a confidence level confirming whether or not the media object belongs to the associated category.

Affinity values between the users and media objects are generated from the users' behaviors interacting with the media objects. For each media object, an affinity value between a user and the media object indicates a confidence level confirming whether or not the user is interested in or relates to the media object.

The numerical attributes of the media objects can also be collected from the web documents referencing the media object. For instance, from a webpage that provides a video stream and lists the resolution of the video stream, the numeric attribute collector can collect the video stream's resolution as a numerical attribute of the video stream.

For each media object, the metadata database 160 organizes and stores the global tags and associated confidence weight values, the categories and associated category weight values, user identifications and associated affinities values, and numeric attributes as metadata of the media object. This information can be represented as a feature vector, with each numeric value representing the weight of the associated dimension (e.g., mapping to global tags, categories and user identifications).

The media content analysis system 100 can utilize the media content metadata to assess a user's relationships with the metadata and the media objects. FIG. 6 illustrates an example process for determining user feature vectors based on metadata of media objects, according to various embodiments. Given a list of media objects and their respective affinity values with regard to a particular user's history interacting with the media objects, the client service module 170 of the media content analysis system 100 can generate a user feature vector that represent that user's relationships with the metadata.

In the illustrated embodiment, metadata of three video files V1, V2 and V3 are presented. These metadata of video files V1, V2 and V3 can be stored in, e.g., the metadata database 160. The video file V1 has a global tag HILARIOUS with a confidence weight value of 70% (<HILARIOUS, 70%>), and an affinity value of 60% with a user U1 (<U1, 60%>). The video file V2 has a category TRAGEDY with a category weight value of 90% (<TRAGEDY, 90%>), and an affinity value of 85% with the user U1 (<U1, 85%>). The video file V3 has a global tag HILARIOUS with a confidence weight value of 40% (<HILARIOUS, 40%>), a global tag PG13 with a confidence weight value of 95% (<PG13, 95%>), an affinity value of 75% with the user U1 (<U1, 75%>), and an affinity value of 80% with another user U2 (<U2, 80%>).

Each element of the feature vector of a particular user represents a media content metadata, such as a global tag, a category, or a user identification (either the identification of this particular user or an identification of another user). The value of the element represents the particular user's relationship with the metadata represented by the element. In the illustrated embodiment, the feature vector of U1 can have at least four elements. The elements represent the tag HILARIOUS, the tag PG13, the category TRAGEDY, and the user U2.

For instance, a value of an element representing a global tag represents the particular user's relationship with that global tag. In the illustrated embodiment, the value of the element representing the tag HILARIOUS can be calculated as a weighted average of the confidence weight values associated with HILARIOUS for the video files. The affinity values between the user U1 and the video files V1, V2 and V3 serve as the weights. For example, the HILARIOUS element can be (60%*70%+75%*40%)/2=36%,

Similarly the value of the element representing the tag PG13 can be calculated as a weighted average of the confidence weight values associated with PG13 for the video files. The PG13 element can be 75%*95%=71%.

In alternative embodiments, the element values of the feature vector can be calculated in other ways using the global tags with confidence weight values, categories with category weight values, and user identifications with affinity values. For example, the calculation can give more weight to recently viewed media objects. The client service module 170 can, e.g., use a Bayesian estimator to adjust the affinities of the media objects to take into account the time since the media objects were recently viewed and other additional inputs (e.g., repeat counts, social actions, etc.). Thus, the feature vectors are determined in a way biased to “fresher” media objects.

Likewise, a value of an element representing a category represents the particular user's relationship with that category. In the illustrated embodiment, the value of the element representing the category TRAGEDY can be calculated as a weighted average of the category weight values associated with TRAGEDY for the video files. The affinity values between the user U1 and the video files V1, V2 and V3 serve as the weights. For example, the TRAGEDY element can be 85%*90%=77%.

A value of an element (representing a user identification) represents the particular user's relationship with that user. In the illustrated embodiment, the value of the element representing the user U2 can be calculated as a weighted average of the affinity values associated with U2 for the video files. The affinity values between the user U1 and the video files V1, V2 and V3 serve as the weights. For example, the U2 element can be 75%*80%=60%.

The feature vector can be a sparse vector; i.e., some elements of the feature vector can have zero, null, or missing values. The zero value indicates that the particular user has no relationship with certain global tags, categories, or users represented by the zero-value elements. The client service module 170 can store the feature vectors for the users in the metadata database 160 as well.

Based on the metadata of the media objects and the feature vectors of the users, the client service module 170 can recommend media objects in various ways. FIG. 7 illustrates an example of a process of recommending a media object to a user, according to various embodiments. Initially, the client service module 170 determines a current feature vector of the user (step 710). The element values of the feature vector represent the particular user's relationships with the metadata represented by the elements. An example of a feature vector is illustrated in FIG. 6. If the metadata database 160 stores the feature vector for the particular user, and assuming the feature vector is up-to-date, the client service module 170 can retrieve the feature vector from the database 160. If the metadata database 160 does not store the feature vector for the particular user, the client service module 170 can generate the feature vector, e.g., in a way illustrated in FIG. 6.

Then the client service module 170 determines one or more neighboring users of the particular user in various ways. For example, the client service module 170 identifies one or more neighboring users based on the vector distances between these various features vectors through a K-nearest neighbors algorithm (step 720). In this case, the service can select a group of users that minimize a distance function on a subset of the feature vector. For example, the service can use a Jaccard distance function over the elements of the feature vector that correspond with the classified categories. The result will be a group of users that have similar tastes in regard to the predefined categories.

Alternatively, the client service module 170 can examine the feature vector of the particular user, and identify one or more elements representing other users that have the highest affinity values. Client service module 170 then selects these users represented by the elements with highest affinity values.

Subsequently, the client service module 170 determines media objects that have high affinity values with the neighboring users based on the user vectors of the neighboring users (step 730). The client service module 170 selects media objects that have the highest collective affinity values under a collaborative filtering scheme (740). The client service module 170 then sends the selected media objects to a client device (e.g., 192 or 194) as recommendations (step 750).

FIG. 8 illustrates another example of a process of recommending a media object, according to various embodiments. Initially, the client service module 170 determines a feature vector of the user (step 810). Then the client service module 170 calculates vector distances between the user feature vector and media object feature vectors (step 820). Notice that metadata of a media object stored in the database 160 form a feature vector in the same vector space of the user feature vector. In other words, user feature vectors and media object feature vector can have the same types of elements (e.g., representing the same set of global tags, categories, or user identities), but have different element values (e.g., confidence weight values, category weight values, or affinity values).

The client service module 170 selects the media object feature vectors that have the lowest vector distances from the user feature vector (step 830). Then the client service module 170 sends the selected media objects to a client device (e.g., 192 or 194) as recommendations (step 840).

The ways of recommending media objects can vary. For instance, the processes illustrated in FIGS. 7 and 8 can be combined. The client service module 170 can consider both the affinities of the neighboring users and vector distances from the media objects when selecting media objects for recommendation. A score for each media object may be calculated based on the affinities between the media object and the neighboring users, as well as the vector distance between a media object feature vector and the feature vector of the particular user. Then the calculated scores for the media objects are used to select the recommendations of media objects.

FIG. 9 illustrates an example of a client device receiving a media object recommendation, according to various embodiments. The client device 900 includes a seamless media navigation application 910, a media object caching proxy 920, and a user input/gesture component 930. The user input/gesture component 930 is responsible for recognizing user inputs and gestures for operating the client device 900, and particularly for operating the seamless media navigation application 910 running on the client device 900. For instance, if the client device 900 includes a touch screen component, the user input/gesture component 930 recognizes the touch gestures when users touch and/or move the screen using fingers or styli. The user input/gesture component 930 translates the user inputs and gestures into commands 935 and sends the command 935 to the seamless media navigation application 910.

The seamless media navigation application 910 is responsible for playing media objects and navigating through different media objects and media channels. To play a media object, the seamless media navigation application 910 sends a media object request 915 targeting to a media content delivery server 940 that hosts the media object. The media object caching proxy 920 intercepts the requests 915 for the media object contents and relays the requests 915 to the media content delivery server 940 on behalf of the application 910. The media object caching proxy 920 receives and caches the media object content bytes 942 from the media content delivery server 940 in a local storage or memory. The proxy 920 then forwards the media object content bytes 942 to satisfy the requests 915 from the application 910 directly from the local storage or memory.

Since the media contents are pre-buffered locally by the proxy 920, the application can switch between media objects seamlessly. The proxy 920 is transparent to both the application 910 and the media content delivery server 940 as they are not necessarily aware of the existence of the proxy 920.

Based on the metadata of the user operating the client device 900 and/or metadata of media objects that are playing or have been played on the client device 900, the media content analysis system 950 sends media object recommendation 952 to the seamless media navigation application 910. The application 910 may present the recommendation to the user via an output component (e.g. display), and sends a request 915 for retrieving contents of the recommended media object.

The media object caching proxy 920 again intercepts the request and receives and caches the media object content bytes 947 from a media content delivery server 945. When the seamless media navigation application 910 switches between playing one media object to another media object based on user inputs, the application 910 can switch seamlessly without the need to wait for the content delivered from external servers, because the contents are pre-cached by the media object caching proxy 920.

FIG. 10 is a high-level block diagram showing an example of a processing system which can implement at least some operations related to media content analysis or recommendation. The processing device 1000 can represent any of the devices described above, such as a media content analysis system, a media content delivery server, a social media server, a general content server or a client device. As noted above, any of these systems may include two or more processing devices such as those represented in FIG. 10, which may be coupled to each other via a network or multiple networks.

In the illustrated embodiment, the processing system 1000 includes one or more processors 1010, memory 1011, a communication device 1012, and one or more input/output (I/O) devices 1013, all coupled to each other through an interconnect 1014. The interconnect 1014 may include one or more conductive traces, buses, point-to-point connections, controllers, adapters and/or other conventional connection devices. The processor(s) 1010 may include, for example, one or more general-purpose programmable microprocessors, microcontrollers, application specific integrated circuits (ASICs), programmable gate arrays, or the like, or a combination of such devices. The processor(s) 1010 control the overall operation of the processing device 1000. Memory 1011 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 1011 may store data and instructions that configure the processor(s) 1010 to execute operations in accordance with the techniques described above. The communication device 1012 may include, for example, an Ethernet adapter, cable modem, Wi-Fi adapter, cellular transceiver, Bluetooth transceiver, or the like, or a combination thereof. Depending on the specific nature and purpose of the processing device 1000, the I/O devices 1013 may include devices such as a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A media content analysis system for media content metadata of media objects, the system comprising:
a processor;
a network interface for retrieving web documents from web servers, wherein the web documents reference media objects;
a behavior analyzer configured, when executed by the processor, to generate affinity values between user identities and the media objects based on online behaviors of the user identities interacting with the media objects;
a document extractor configured, when executed by the processor, to generate metadata of the media objects based on the web documents; and
a client service module configured, when executed by the processor, to determine a recommendation of a media object to a user identity based on the affinity values and the metadata of the media objects.

2. The system of claim 1, wherein the document extractor includes:
a global tag generator configured, when executed by the processor, to generate global tags and associated confidence weights for at least one media object of the media objects, based on the web documents referencing the media object, wherein the confidence weight values indicate confidence levels confirming the media object relates to the corresponding global tags; and
a category classifier configured, when executed by the processor, to generate category weight values associated with a pre-determined categories for the media object, based on the web documents referencing the media object, wherein the category weight values indicate confidence levels confirming the media object belongs to the corresponding categories;
wherein the metadata of the media object include the global tags, the confidence weight values and the category weight values.

3. The system of claim 2, wherein the client service module is further configured to generate a feature vector of the user identity among the user identities, wherein elements of the feature vector represent relationships of the user identity to metadata including the global tags, the categories, or other user identities.

4. The system of claim 3, wherein the recommendation of the media object to the user identity is determined based on the feature vector of the user identity.

5. A method for aggregating and analyzing media content information, the method comprising:
retrieving a plurality of web documents that reference a first media object from web domains;
generating raw metadata tags of the first media object by parsing the web documents through parser templates specific to the web domains that host the web documents;
determining global tags from the raw metadata tags by ranking the raw metadata tags based on confidence weight values associated with the raw metadata tags;
feeding textual contents of the web documents into a machine learning classifier that has been trained for a set of categories;
receiving, from the machine learning classifier, category weight values of the first media object corresponding to the set of categories; and
storing, at a media information database, the global tags and their associated confidence weight values and the category weight values corresponding to the set of categories as metadata associated with the first media object.

6. The method of claim 1, further comprising:
determining at least one user identity representing a party of interest;
collecting behavior metrics of the user identity toward at least the first media object based on one or more online behaviors of the user identity that associate with the first media object;
determining an affinity value between the user identity and the first media object based on the behavior metrics; and
storing, at the media information database, the user identity and the affinity value as metadata associated with the first media object.

7. The method of claim 6, further comprises:
determining a feature vector of the user identity based on metadata of media objects, wherein the metadata of media objects include confidence weight values of global tags of the media objects, category weight values of categories of the media objects, affinity values between user identities, and the media objects;
selecting at least a second media object based on the feature vector of the user identity; and
recommending the second media object to a client device.

8. The method of claim 6, wherein the behavior metrics include:
media objects consumed;
a number of the media objects consumed;
media objects skipped;
media objects liked;
media objects shared; or
media objects rated.

9. The method of claim 7, wherein the selecting the second media object comprises:
identifying one or more neighboring user identities of the user identity; and
determining the second media object that has high affinity values with the neighboring user identities.

10. The method of claim 9, wherein the neighboring user identities are recognized based on vector distances between the feature vector of the user identities and the feature vectors of the neighboring user identities.

11. The method of claim 9, wherein the neighboring user identities are recognized based on values of a plurality of elements of the feature vector of the user identity, the plurality of elements representing other user identities.

12. The method of claim 7, wherein the selecting the second media object comprises:
calculating vector distances between the feature vector of the user identity and feature vectors of multiple media objects; and
determining the second media object that has a feature vector having the shortest vector distance as defined by a custom distance function with the feature vector among the media objects.

13. The method of claim 6, further comprising:
anonymizing the party of interest before storing the affinity value between the first media object and the user identity into the media information database.

14. The method of claim 5, wherein the web documents that reference the first media object include:
webpage describing contents or attributes of the first media object;
webpage hosting the first media object;
social media post or comment that mentions or links to the first media object; or
general web content that references the first media object;

15. The method of claim 5, wherein the parser templates include regular expressions specific to the web domains that host the web documents for extracting raw metadata tags from the web documents.

16. The method of claim 5, wherein the parser templates include protocol parsers for extracting contents from the web documents based on network protocols.

17. The method of claim 5, wherein a confidence weight value of a particular raw metadata tag is determined based on a frequency of the raw metadata tag appearing in the web documents, offsetting by a frequency of the raw metadata tag in a corpus collection.

18. The method of claim 5, further comprising:
correcting typographical errors in the web documents;
excluding common words from the raw metadata tags;
stemming and lemmatizing the raw metadata tags; or
disambiguating the raw metadata tags.

19. The method of claim 5, wherein the machine learning classifier is a natural language processing classifier.

20. The method of claim 5, wherein the category weight values indicate confidence levels confirming the first media object belongs to the corresponding categories; wherein the confidence weight values indicate confidence levels confirming the first media object relates to the corresponding global tags.

21. The method of claim 5, wherein the media object comprises a video file, a video stream, an audio file, an audio stream, an image, a game, an advertisement, or a text.

22. The method of claim 5, wherein the web documents include:
HyperText Markup Language (HTML) documents;
Extensible Markup Language (XML) documents;
JavaScript Object Notation (JSON) documents;
Really Simple Syndication (RSS) documents; or
Atom Syndication Format documents.

23. A processor-executable storage medium storing instructions, comprising:
instructions for aggregating network textual contents that relate to online media objects;
instructions for determining affinity values which indicate how closely the online media objects are related to users, based on the users' interactions with the online media objects;
instructions for determining metadata of the online media objects based on the network textual contents; and
instructions for recommending an online media object among the online media objects to a user among the users, based on the affinity values and metadata of the online media objects.

24. The storage medium of claim 23, wherein the instructions for determining metadata of the online media objects comprises:
instructions for determining global tags for at least an online media object of the online media objects by extracting raw tags from the network textual contents referencing the online media object and ranking the raw tags;
instructions for generating category weight values for the online media object corresponding to a set of categories by feeding the network textual contents to a machine learning classifier that has been trained to predict memberships among the set of categories; and
instructions for assigning the global tags and category weight values as metadata associated with the online media object.

25. The storage medium of claim 23, wherein the instruction for recommending the online media object comprises:
instructions for constructing feature vectors of the users, wherein the elements of the feature vectors represent the respective users' relationships to the metadata of the online media objects; and
instructions for recommending the online media object to the user, based on at least the feature vector of the user.
